(19) United States
(12) Patent Application Publication
(10) Pub. No.: US 2024/0221127 A1
(43) Pub. Date: Jul. 4, 2024

(54) IMAGE PROCESSING METHOD, DEVICE, AND STORAGE MEDIUM

(71) Applicant: SHENZHEN TRANSSION HOLDINGS CO., LTD., Guangdong (CN)

(72) Inventor: Hongwei WANG, Guangdong (CN)

(73) Assignee: SHENZHEN TRANSSION HOLDINGS CO., LTD., Guangdong (CN)

(21) Appl. No.: 18/605,699

(22) Filed: Mar. 14, 2024

Related U.S. Application Data
(63) Continuation of application No. PCT/CN2021/122444, filed on Sep. 30, 2021.

(51) Int. Cl. G06T 5/50; G06V 10/40; G06V 10/70

(52) U.S. Cl. CPC G06T 5/50; G06T 2200/21; G06V 10/40; G06V 10/70

(57) ABSTRACT

The present application proposes an image processing method, a device and a storage medium. The image processing method includes the following steps: obtaining first image data; determining or generating a target data stream according to a data stream format; and performing image processing on the first image data according to the target data stream. In the present application, by setting the data stream format, the target data stream based on the data stream format can include the first image data and/or characteristic data of the first image data, and the image processing on the first image data can be implemented according to the target data stream, improving the image processing efficiency as well as the compatibility and consistency of a computational photography system.

### CROSS-REFERENCE TO RELATED APPLICATION

This application is a continuation of international application of PCT application serial no. PCT/CN2021/122444 filed on Sep. 30, 2021. The entirety of the above mentioned patent application is hereby incorporated by reference herein and made a part of this specification.

### TECHNICAL FIELD

The present application relates to computational photography technology, and in particular, to an image processing method, a device and a storage medium.

### BACKGROUND

In some implementations, most of the implementation solutions for the computational photography system are transformation based on the original camera system. The inventor found that there are at least the following problems: the image processing efficiency is relatively low, and/or the compatibility and consistency of the computational photography system are relatively poor.

The foregoing description is intended to provide general background information and does not necessarily constitute prior art.

### SUMMARY

In order to solve the above technical problems, embodiments of the present application provide an image processing method, a device and a storage medium.

In a first aspect, the present application provides an image processing method, and the method includes the following steps:
S1, obtaining first image data;
S2, determining or generating a target data stream according to a data stream format; and
S3, performing image processing on the first image data according to the target data stream.

In an implementation, the step S3 includes:
parsing the target data stream, and performing image processing on the first image data to obtain second image data and characteristic data of the second image data.

In an implementation, the step S1 includes at least one of:
obtaining the first image data according to an imaging control instruction and/or an image obtaining instruction;
obtaining characteristic data of the first image data.

In an implementation, the characteristic data of the first image data includes at least one of: basic image information, imaging information, and semantic information of the first image data;
after the obtaining the characteristic data of the first image data, the method includes at least one of:
assigning the basic image information of the first image data to the target data stream;
assigning the imaging information of the first image data to the target data stream;
assigning the semantic information of the first image data to the target data stream.

In an implementation, the obtaining the characteristic data of the first image data includes:
obtaining the basic image information of the first image data through an imaging module of a photography system;
and/or, obtaining the imaging information of the first image data through the imaging module and/or an auxiliary imaging module of the photography system.

In an implementation, the step S2 includes at least one of:
determining or generating the target data stream by arranging at least two data items sequentially in a first specific order;
determining or generating the target data stream by arranging respective pieces of characteristic information in a third specific order.

In an implementation, the method further includes at least one of:
each of the data items includes at least one type of characteristic information;
respective pieces of characteristic information in each of the data items are arranged in a second specific order.

In a second aspect, the present application further provides an image processing method, and the method includes the following steps:
S10, obtaining first image data according to a preset rule;
S20, determining or generating a target data stream according to the first image data; and
S30, performing image processing on the first image data based on the target data stream.

In an implementation, the step S10 includes at least one of:
if the preset rule instructs to add basic image information to a data stream, obtaining basic image information of the first image data through an imaging module of a photography system;
if the preset rule instructs to add imaging information to a data stream, obtaining imaging information of the first image data through the imaging module and/or an auxiliary imaging module of the photography system;
if the preset rule instructs to add at least one type of semantic information to a data stream, obtaining at least one type of semantic information of the first image data.

In an implementation, if the preset rule instructs to add at least one type of semantic information to a data stream, obtaining at least one type of semantic information of the first image data includes at least one of:
if the preset rule instructs to add basic semantic information to a data stream, obtaining basic semantic information of the first image data;
if the preset rule instructs to add optional semantic information to a data stream, obtaining at least one type of optional semantic information of the first image data.

In an implementation, the step S10 includes:
in response to a call to a first interface, obtaining the preset rule from an entry parameter of the first interface, and obtaining the first image data according to the preset rule.

In an implementation, the step S20 includes:
in response to a data request from an algorithm module to which a data stream flows, obtaining data required by the algorithm module; and
after obtaining the data required by the algorithm module, assigning the obtained data to the data stream to obtain the target data stream.

In an implementation, in response to the data request from the algorithm module to which the data stream flows, obtaining the data required by the algorithm module includes:
in response to a call to a second interface from any algorithm module, determining or obtaining the data required by the algorithm module according to an input parameter of the second interface, and transmitting the obtained data to the algorithm module.

In an implementation, the step S30 includes:
parsing the target data stream, and performing image processing on the first image data to obtain second image data and/or characteristic data of the second image data.

In a third aspect, the present application further provides an image processing apparatus, including:
a data obtaining unit configured to perform step S1: obtaining first image data;
a data stream unit configured to perform step S2: determining or generating a target data stream according to a data stream format; and
an image processing unit configured to perform step S3: performing image processing on the first image data according to the target data stream.

In a fourth aspect, the present application further provides an image processing apparatus, including:
a data obtaining unit configured to perform step S10: obtaining first image data according to a preset rule;
a data stream unit configured to perform step S20: determining or generating a target data stream according to the first image data; and
an image processing unit configured for S30: performing image processing on the first image data based on the target data stream.

In a fifth aspect, the present application further provides an electronic device, including: a processor and a memory;
the memory stores computer execution instructions; and
when the computer execution instructions are executed by the processor, the image processing method described in any of the above aspects is implemented.

In a sixth aspect, the present application further provides a computer-readable storage medium in which computer execution instructions are stored, and when the computer execution instructions are executed by a processor, the image processing method described in any of the above aspects is implemented.

In a seventh aspect, the present application further provides a computer program product including a computer program, where when the computer program is executed by a processor, the image processing method described in any of the above aspects is implemented.

In the image processing method, the device and the storage medium provided by the present application, by setting a specific data stream format, the data stream based on this data stream format can include the first image data and/or the characteristic data of the first image data, and the image processing on the first image data can be implemented according to the target data stream. This improves the image processing efficiency, and when applied to a computational photography system, improves the compatibility and consistency of the computational photography system.

### BRIEF DESCRIPTION OF DRAWINGS

The accompanying drawings, which are incorporated in and constitute a part of this specification, illustrate embodiments consistent with the present application and serve to explain the principles of the present application together with the description. In order to more clearly illustrate the technical solutions of the embodiments of the present application, the following will briefly introduce the drawings required for the description of the embodiments. Obviously, for those of ordinary skill in the art, other drawings can also be obtained based on these drawings without creative efforts.

FIG. 1 is a flowchart of an image processing method according to an embodiment of the present application.

FIG. 2 is a flowchart of another image processing method according to an embodiment of the present application.

FIG. 3 is a flowchart of another image processing method according to an embodiment of the present application.

FIG. 4 is a flowchart of another image processing method according to an embodiment of the present application.

FIG. 5 is a schematic structural diagram of an image processing apparatus according to an embodiment of the present application.

FIG. 6 is a schematic structural diagram of an electronic device according to an embodiment of the present application.

The realization of the purpose, functional features and advantages of the present application will be further described with reference to the embodiments and the accompanying drawings. Through the above-mentioned drawings, specific embodiments of the present application have been shown, and will be described in more detail below. These drawings and text descriptions are not intended to limit the scope of the concept of the present application in any way, but are intended to illustrate the concept of the present application for those skilled in the art with reference to specific embodiments.

### DESCRIPTION OF EMBODIMENTS

Example embodiments will be described in detail herein, examples of which are illustrated in the accompanying drawings. When the following description involves the drawings, the same numerals in different drawings refer to the same or similar elements unless otherwise indicated. The implementations described in the following example embodiments do not represent all implementations consistent with the present application. Rather, they are merely examples of apparatuses and methods consistent with some aspects of the present application as detailed in the appended claims.

It should be noted that herein the terms “comprising”, “including” or any other variations thereof are intended to cover a non-exclusive inclusion, such that a process, method, article or apparatus that includes a series of elements not only includes those elements, but also includes other elements not expressly listed or inherent in the process, method, article or apparatus. Without further limitation, an element defined by the statement “comprises a . . . ” does not exclude the presence of other identical elements in the process, method, article or apparatus including the element. In addition, components, features, or elements with the same name in different implementations of the present application may have the same meaning or may have different meanings. The specific meaning needs to be determined based on their explanation in the specific embodiment or further in combination with the context of the specific embodiment.

It should be understood that although the terms first, second, third, etc. may be used herein to describe various information, the information should not be limited to these terms. These terms are only used to distinguish information of the same type from each other. For example, without departing from the scope of this disclosure, first information may also be called second information, and similarly, second information may also be called first information. Depending on the context, the word “if” as used herein may be interpreted as “when” or “at a time when” or “in response to determining that”. Furthermore, as used herein, the singular forms “a”, “an” and “the” are intended to include the plural forms as well, unless the context indicates otherwise. It should be further understood that the terms “comprising” and “including” indicate the presence of stated features, steps, operations, elements, components, items, categories, and/or groups, but do not exclude the presence, occurrence, or addition of one or more other features, steps, operations, elements, components, items, categories, and/or groups. The terms “or”, “and/or”, “including at least one of”, etc. used in the present application may be interpreted as inclusive or may mean any one or any combination. For example, “including at least one of: A, B, C” means “any of the following: A; B; C; A and B; A and C; B and C; A and B and C”. As another example, “A, B or C” or “A, B and/or C” means “any of the following: A; B; C; A and B; A and C; B and C; A and B and C”. Exceptions to this definition occur only when a combination of elements, functions, steps, or operations is inherently mutually exclusive in some manner.

It should be understood that although respective steps in the flowchart in the embodiment of the present application are displayed in sequence as indicated by the arrows, these steps are not necessarily executed in the order indicated by the arrows. Unless explicitly stated herein, the execution of these steps is not strictly limited in order, and they may be executed in other orders. Moreover, at least some of the steps in the figure may include multiple sub-steps or multiple stages. These sub-steps or stages are not necessarily executed at the same time, but may be executed at different time, and are not necessarily executed sequentially, but may be executed in shifts or alternately with other steps or at least part of sub-steps or stages of other steps.

Depending on the context, the words “if” or “in a case that” as used herein may be interpreted as “when” or “at a time when” or “in response to determining that” or “in response to detecting that”. Similarly, depending on the context, the phrase “if it is determined that” or “if it is detected that (stated condition or event)” may be interpreted as “when it is determined that” or “in response to determining that” or “when (stated condition or event) is detected” or “in response to detecting that (a stated condition or event)”.

It should be noted that step symbols such as S10 and S20 are used herein for the purpose of describing the corresponding content more clearly and concisely, and do not constitute a substantial restriction on an order. In specific implementations, those skilled in the art may execute S20 first and then S10, etc., but these should be within the protection scope of the present application.

The image processing method specifically provided by the present application is applied to a computational photography system. Most of the implementation solutions of the computational photography system are transformation based on the original camera system. Image data obtained from the camera system includes captured image data itself, but does not include detailed characteristic information such as sensor information corresponding to the image, whether certain preprocessing has been undergone, image semantic information, etc. When performing computational photography image processing, if multiple pieces of characteristic information corresponding to the image data need to be obtained, it is necessary to call several times the query interfaces corresponding to the respective pieces of characteristic information to obtain the corresponding characteristic information.

Illustratively, taking the Android-based camera system (Android Camera) framework as an example, a calling module sets an output format of image data captured by an underlying camera device through a void setParameters(Camera.Parameters params) interface. The calling module obtains the captured image data itself by calling, according to an imaging control request, an application programming interface (such as Camera.PictureCallback( )) provided by the camera system. If it is desired to parse the image data, calling the corresponding query interface needs to be done to obtain an image encoding mode, height, width and other characteristic information from Camera.Parameters, and to parse the captured image data based on these characteristic information. In an implementation, the calling module may be any functional module that performs computational photography image processing, which calls a corresponding algorithm module through the application programming interface to implement the function of computational photography image processing.

In order to be able to query the sensor information of the captured image data, whether certain preprocessing has been undergone, image semantic information and other characteristic information, the private interface for querying various characteristic information may be extended, and the corresponding characteristic information can be queried by calling the query interface. However, this requires the support of various mobile manufacturers, and the query interface needs to be called several times during the computational photography image processing process, which is cumbersome, resulting in low efficiency of computational photography image processing, and is not conducive to the integration of computational photography algorithm modules. Different manufacturers extend private interfaces with inconsistent definitions of image formats, resulting in complex image data formats in the interactive data streams between various modules and difficulty in parsing; the imaging information, semantic information, etc. required by modules for performing computational photography image processing are scattered in various modules, which is not conducive to searching.

Since the hardware architecture and imaging devices of mobile terminals of various mobile manufacturers may be different, and there are also differences in the imaging control process and image data processing process of computational photography as well as related control commands, image data definition and format, etc., extending the private query interface brings compatibility and consistency problems.

In the image processing method provided by the present application, by setting a specific data stream format, a data stream based on this data stream format can include first image data and/or characteristic data of the first image data. In an implementation, first image data and/or characteristic data of the first image data may be obtained; according to a data stream format, a data stream including the first image data and/or the characteristic data of the first image data is generated, in this way, during subsequent image processing on the first image data, the first image data and/or the characteristic data of the first image data can be obtained by parsing the data stream without a need to call the query interface of each piece of characteristic data to obtain the characteristic data, which improves image processing efficiency and reduces the dependence of the algorithm module for image processing on other modules (such as the module corresponding to the query interface). When applied to the computational photography system, the method can improve the compatibility and consistency of the computational photography system.

The technical solutions of the embodiments of the present application and how the technical solutions of the present application solve the above technical problems will be described in detail below with specific embodiments. The following specific embodiments may be combined with each other, and the same or similar concepts or processes may not be described again in some embodiments. The technical solutions of the embodiments of the present application will be described below with reference to the accompanying drawings.

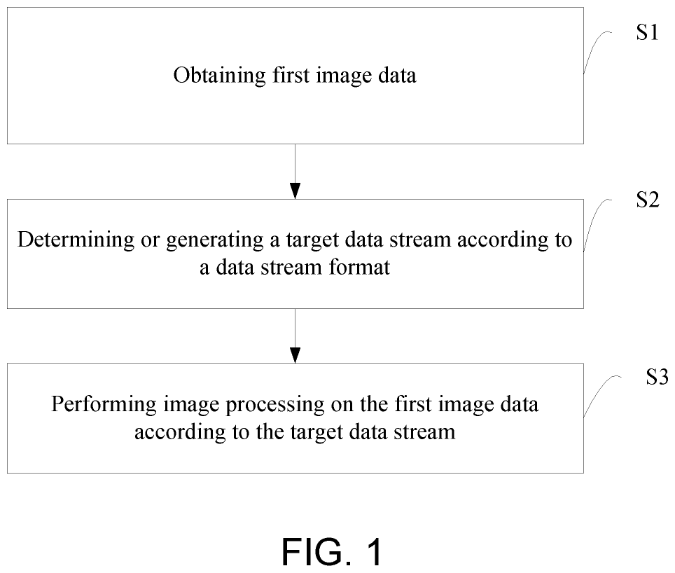

FIG. 1 is a flowchart of an image processing method according to an embodiment of the present application. The execution body of the method provided in this embodiment may be an electronic device with image processing function (such as computational photography function). For example, the execution body may be a mobile terminal such as a smartphone, a tablet computer, or a personal computer, a computational photography server, etc. In other embodiments, the execution body may further be other electronic devices, which are not specifically limited here. As shown in FIG. 1, the specific steps of the method are as follows.

Step S1, obtaining first image data.

In an implementation, the first image data refers to an original image on which image processing needs to be performed, and a target image requested by a user can be obtained by performing image processing on the original image.

The first image data may include: an image captured by an imaging module, and/or an image obtained from other modules.

Step S2, determining or generating a target data stream according to a data stream format.

In an implementation, the target data stream includes the first image data.

In this embodiment, the data stream format is preset and is a format of a data stream including the first image data and/or characteristic data of the first image data.

In this embodiment, by setting the data stream format in advance, each algorithm module and/or functional module can assign the first image data to be processed and/or the characteristic data of the first image data to the target data stream, so that the target data stream can include the first image data and the characteristic data of the first image data.

After the characteristic data of the first image data is obtained, a target data stream including the first image data and/or the characteristic data of the first image data is determined or generated according to the data stream format, so that the first image data and/or the characteristic data of the first image data is assigned to the target data stream. During subsequent image processing, the first image data and/or the characteristic data of the first image data can be directly extracted from the target data stream.

Step S3, performing image processing on the first image data according to the target data stream.

When performing image processing, according to the data stream format of the target data stream, the first image data and/or respective pieces of characteristic information in the characteristic data of the first image data can be extracted from the target data stream.

In an implementation, according to the respective pieces of characteristic information in the characteristic data of the first image data, one or more pieces of characteristic information used in the current image processing can be selected from the characteristic data, and corresponding image processing can be performed on the first image data.

In this way, when performing image processing, the required characteristic data of the first image data can be obtained directly from the target data stream without a need to call the query interface of each piece of characteristic data to obtain the characteristic data, which improves the image processing efficiency, reduces the dependence of the algorithm module for image processing on other modules (such as the module corresponding to the query interface) and improves the compatibility and consistency of the computational photography system.

In the embodiment of the present application, a data stream format is set, captured first image data and characteristic data of the first image data are obtained, and a target data stream including the first image data and the characteristic data is generated according to the data stream format, where the target data stream includes not only the captured first image data, but also the characteristic data of the first image data. When performing any image processing on the first image data, the first image data and the characteristic data of the first image data can be obtained by parsing the target data stream without a need to call the query interface of each piece of characteristic data to obtain the characteristic data, which improves the image processing efficiency, reduces the dependence of the algorithm module for image processing on other modules (such as the module corresponding to the query interface), and improves the compatibility and consistency of the computational photography system.

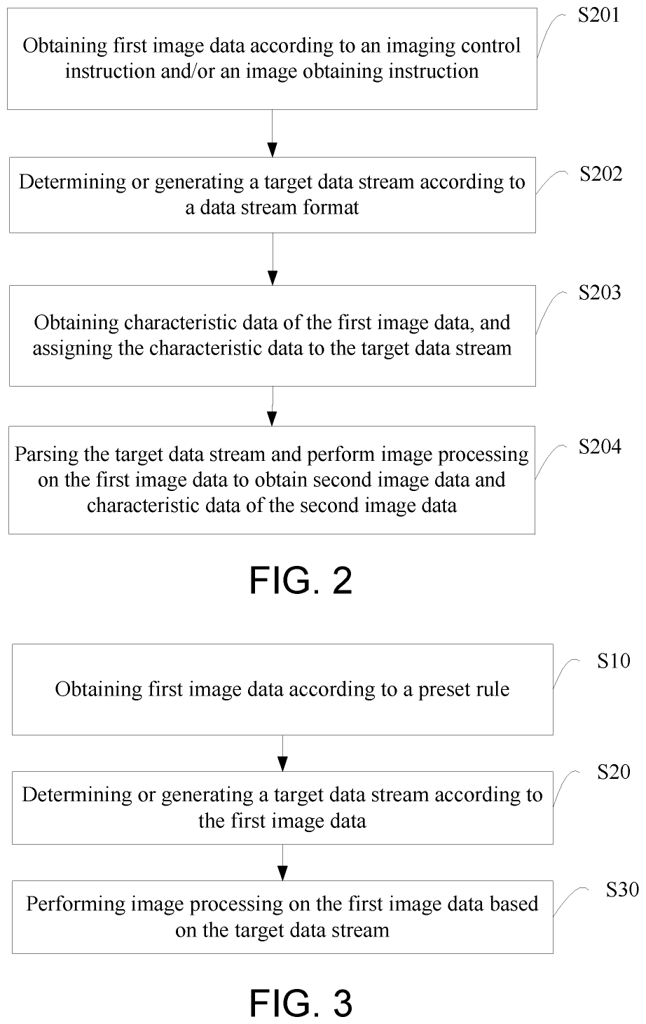

FIG. 2 is a flowchart of another image processing method according to an embodiment of the present application. Based on the above embodiment corresponding to FIG. 1, in this embodiment, step S3 includes: parsing the target data stream, and performing image processing on the first image data to obtain second image data and characteristic data of the second image data.

As shown in FIG. 2, the specific steps of this method are as follows:

Step S201, obtaining first image data according to an imaging control instruction and/or an image obtaining instruction.

In an implementation, the first image data refers to an original image on which image processing needs to be performed, and a target image requested by a user can be obtained by performing image processing on the original image.

The first image data may include: an image captured by an imaging module, and/or an image obtained from other modules.

In an implementation, obtaining the first image data includes: obtaining captured image data according to the imaging control instruction; and/or obtaining existing image data according to the image obtaining instruction.

Illustratively, the captured image data may be obtained from a camera service according to the imaging control instruction.

Illustratively, the existing image data may be obtained through an image providing service according to the image obtaining instruction.

Step S202, determining or generating a target data stream according to a data stream format.

In an implementation, the data stream format is preset and is a format of a data stream including the first image data and/or characteristic data of the first image data.

In this step, after the first image data and/or the characteristic data of the first image data is obtained, the target data stream including the first image data and/or the characteristic data of the first image data may be determined or generated according to the data stream format. In an optional implementation of this embodiment, in the above step S2, the target data stream may be determined or generated by arranging at least two data items sequentially in a first specific order.

In an implementation, each of the data items includes at least one type of characteristic information; respective pieces of characteristic information in each of the data items are arranged in a second specific order.

In the data stream format of the target data stream, the data stream includes the first image data and the characteristic data of the first image data, the characteristic data of the first image data includes the at least two data items arranged sequentially in a first specific order, and each of the data items includes one type of characteristic information of the characteristic data. In an implementation, each type of characteristic information includes at least one piece of characteristic information; the respective pieces of characteristic information of each data item are arranged sequentially in the second specific order.

In an implementation, the first specific order is a preset arrangement order of respective data items, and may be flexibly set according to the needs of the actual application scenario and the number of data items included in the characteristic data. This embodiment does not pose specific limitation to the specific arrangement order for the first specific order.

The second specific order refers to an arrangement order of the respective characteristic information of each data item, and may be flexibly set according to the needs of the actual application scenario and the number of pieces of characteristic information included in the data item. This embodiment does not pose specific limitation to the specific arrangement order for the second specific order.

Illustratively, the characteristic data may include a basic image information data item, an imaging information data item, and a semantic information data item, and these three data items are closely arranged in the first specific order. In an implementation, each data item includes attribute values corresponding to multiple pieces of characteristic information.

In addition, there may also be a corresponding attribute tag for each piece of characteristic information, to uniquely identify one piece of characteristic information. For setting the second specific order of the respective pieces of characteristic information of the data item, the second specific order of respective attribute tags may be determined by sorting the attribute tags corresponding to the respective pieces of characteristic information of the data item.

In an implementation, in addition to one or more pieces of characteristic information, each data item may further include a data item flag and a data item length. In an implementation, the data item flag may be located at a head of the data item to distinguish different data items. By setting the data item flag and data item length of each data item, different data items can be easily parsed out, reducing the complexity of data stream parsing and improving the efficiency of data stream parsing.

For example, the format of the basic image information data item is taken as an example to illustrate the format of the data item. The format of a basic image information data item of a 1080×1920 grayscale image may be shown as Table 1 below.

TABLE 1

| Memory offset | | | Attribute |
|---|---|---|---|
| value | | Attribute value | value |
| (Hexadecimal) | Description value | (Hexadecimal) | (Decimal) |
| 0000 | Data item flag | 0001 | 1 |
| 0002 | Data item length | 0000 0023 | 35 |
| 0006 | Image data length | 0000 0000 001F E000 | 2088960 |
| 000E | Image width | 0000 0500 | 1080 |
| 0012 | Image height | 0000 0780 | 1920 |
| 0016 | Image format | 0000 | 0 |
| 0018 | Step size | 0000 0440 | 1088 |
| 001C | Filling width | 0000 0008 | 8 |
| 0020 | Image frame type | 00 | 0 |
| 0021 | Image frame | 0000 | 0 |
| | number | | |

As shown in Table 1, the basic image information data item may include: a data item flag, a data item length, an image width, an image height, an image format, a step size, a filling width, an image frame type and an image frame number.

In an implementation, the data item flag can uniquely mark a data item to distinguish different data items. For example, it is possible to use 0 to represent the basic image information data item, to use 1 to represent the imaging information data item, to use 2 to represent the semantic information data item, etc. In the data stream format, the data items included in the characteristic data may be expanded, and the flag of each data item may be set and adjusted according to the needs of actual application scenarios and are not specifically limited here.

The image format refers to the format of the first Image data. For example, 0 indicates a grayscale image, 1 indicates a RAW format, 2 indicates a YUV420 format, and so on. The attribute values corresponding to different image formats may be set according to the needs of actual application scenarios, and are not specifically limited here.

The image frame type includes single-frame imaging and multi-frame imaging. It is possible to use 0 to represent single-frame imaging and 1 to represent multi-frame imaging. The attribute value corresponding to each image frame type may be set according to the needs of the actual application scenario, and is not specifically limited here.

The image frame number refers to which frame of image the current first image data is when the image frame type is a multi-frame imaging. When the image frame type is single-frame imaging, the image frame number has no practical significance, and the image frame number may be 1, or null, or other default value (such as 0), and is not specifically limited here.

In this implementation, data items in the data stream are closely arranged, and respective pieces of characteristic information in each data item are also closely arranged, so that the memory arrangement occupied by the data stream is compact with less memory occupied. At the same time, the data stream format is simplified and facilitates parsing, reducing the complexity of data stream parsing and improving the efficiency of data stream parsing.

In another optional implementation of this embodiment, in the above step S2, the target data stream may be determined or generated by arranging respective pieces of characteristic information in a third specific order.

In the data stream format of the target data stream, the characteristic data may include multiple pieces of characteristic information, and the multiple pieces of characteristic information are arranged sequentially in a third specific order in the data stream.

In this implementation, the respective pieces of characteristic information may be left uncategorized. The attribute values of all pieces of characteristic information included in the characteristic data are arranged sequentially in the third specific order. The respective pieces of characteristic information are closely arranged, so that the memory arrangement occupied by the data stream is compact with less memory occupied.

In an implementation, the third specific order may be set according to the needs of actual application scenarios, and is not specifically limited here.

Step S203, obtaining characteristic data of the first image data, and assigning the characteristic data to the target data stream.

In an implementation, the characteristic data of the first image data is used to describe basic image information, imaging information, semantic information, etc. of the first image data.

In addition, the characteristic data of the first image data may further include other relevant information of the first image data used in other computational photography image processing processes. This embodiment does not specifically limit the specific content of the characteristic data.

In this step, obtaining the characteristic data of the first image data may be performed before step S202, that is, part of the characteristic data of the first image data may be obtained before step S202.

Illustratively, before step S202, when obtaining the first image data from the imaging module, the basic image information and/or imaging information of the first image data may also be obtained from the imaging module.

At the same time, the characteristic data of the first image data may further be obtained and then assigned to the data stream.

The target data stream including the first image data is determined or generated according to the data stream format; subsequently any algorithm module and/or functional module, after the characteristic data of the first image data is obtained, can assign the characteristic data of the first image data to the data stream according to the data stream format.

In an implementation, the characteristic data of the first image data may include at least one of: basic image information, imaging information, and semantic information of the first image data.

After obtaining the characteristic data of the first image data, assigning the characteristic data to the target data stream may include at least one of the following:
assigning the basic image information of the first image data to the target data stream;
assigning the imaging information of the first image data to the target data stream;
assigning the semantic information of the first image data to the target data stream.

In this embodiment, after one or more pieces of characteristic information of the first image data are obtained, any algorithm module and/or functional module can assign the obtained one or more pieces of characteristic information to the data stream.

In an implementation, the obtaining the characteristic data of the first image data includes:
obtaining the basic image information of the first image data through the imaging module of the photography system; and/or obtaining the imaging information of the first image data through the imaging module and/or the auxiliary imaging module of the photography system.

In an implementation, for obtaining the basic image information of the first image data, the basic image information of the first image data may be obtained through the imaging module of the photography system.

In an implementation, the basic image information describes basic attribute information of the first image data, and the basic image information may include at least one of the following characteristic information of the first image data:
an image data length, an image width, an image height, an image format, a step size, a filling width, an image frame type, an image frame number.

In the computational photography system, the imaging module generates the first image data and can determine basic attribute information of the image.

In this step, the basic image information of the first image data may be obtained from the imaging module of the computational photography system and assigned to the data stream.

In an implementation, the basic image information of the first image data may be assigned by the imaging module to the data stream.

Illustratively, the imaging module obtains the first image data and at the same time obtains the basic image information of the first image data, organizes the basic image information according to the format of the basic image information data item in the data stream format, and assigns the basic image information to the data stream.

In an implementation, for obtaining the imaging information of the first image data, the imaging information of the first image data may be obtained through the imaging module and/or the auxiliary imaging module of the photography system.

In an implementation, the imaging information describes imaging-related attributes of the first image data, and the imaging information may include at least one of the following characteristic information of the first image data:
photosensitivity, an exposure value, a focal length, geographical location information.

In this step, the imaging information of the first image data may be obtained from the imaging module and the auxiliary imaging module of the computational photography system. The imaging information is organized according to the format of the imaging information data item in the data stream format, and then assigned to the data stream.

In an implementation, the semantic information describes high-level semantic attributes of the first image data, and the semantic information may include at least one of the following characteristic information of the first image data:
scene information, an image depth, image semantics.

In this step, an image semantic extraction algorithm may be used to obtain the semantic information of the first image data.

In an implementation, the semantic information of the first image data is organized according to the format of the semantic information data item in the data stream format, and then assigned to the data stream.

Through this step, the characteristic data of the first image data is obtained, and the characteristic data is assigned to the data stream. The obtained target data stream includes not only the captured first image data, but also the characteristic data of the first image data.

Step S204, parsing the target data stream and perform image processing on the first image data to obtain second image data and characteristic data of the second image data.

After the characteristic data of the first image data is assigned to the target data stream, during subsequent image processing, the target data stream is parsed according to the data stream format to obtain the first image data and/or the characteristic data of the first image data.

When performing image processing, the target data stream is parsed according to the data stream format of the data stream, and the first image data and/or respective pieces of characteristic information in the characteristic data of the first image data included in the target data stream can be obtained.

According to the first image data and/or the characteristic data of the first image data obtained through parsing, image processing is performed on the first image data to obtain the second image data and the characteristic data of the second image data. Illustratively, according to the respective pieces of characteristic information in the characteristic data of the first image data, one or more pieces of characteristic information used in the current image processing may be selected from the characteristic data, and corresponding image processing may be performed on the first image data, to obtain the second image data and the characteristic data of the second image data.

In this way, when performing image processing, the required characteristic data of the first image data can be obtained directly from the data stream without calling the query interface of each piece of characteristic data to obtain the characteristic data, which improves image processing efficiency, reduces the dependence of the algorithm module for image processing on other modules (such as the module corresponding to the query interface) and improves the compatibility and consistency of the computational photography system.

In the embodiment of the present application, the data stream format is set, and the data stream based on the data stream format includes the first image data and/or the characteristic data of the first image data. In this embodiment, the obtained first image data may be assigned to the data stream according to the data stream format. In addition, the characteristic data of the first image data may be obtained, and the characteristic data is also assigned to the data stream. The data stream includes not only the first image data to be processed, but also the characteristic data of the first image data. When any algorithm module and/or functional module subsequently performs any image processing on the first image data, the first image data and/or the characteristic data of the first image data can be obtained by parsing the data stream without a need to call the query interface of each piece of characteristic data to obtain the characteristic data, which improves the image processing efficiency and reduces the dependence of the algorithm module for image processing on other modules (such as the module corresponding to the query interface). When applied to the computational photography system, the method can improve the compatibility and consistency of the computational photography system.

Embodiments of the present application provide a data stream format, and the data stream based on this data stream format includes the first image data and/or the characteristic data of the first image data. The characteristic data of the first image data includes multiple data items arranged sequentially in the first specific order. Each data item includes one type of characteristic information of the characteristic data. In an implementation, each type of characteristic information includes one or more pieces of characteristic information. The respective pieces of characteristic information in each data item are arranged sequentially in the second specific order. Each data item may include a data item flag and a data item length. In this way, the respective data items in the data stream are closely arranged, and the respective pieces of characteristic information in each data item are also closely arranged, so that the memory arrangement occupied by the data stream is compact with less memory occupied. At the same time, the data stream format is simplified and facilitates parsing, reducing the complexity of data stream parsing and improving the efficiency of data stream parsing.

FIG. 3 is a flowchart of another image processing method according to an embodiment of the present application. The execution body of the method provided in this embodiment may be an electronic device with computational photography function and/or image processing function. For example, the execution body may be a mobile terminal such as a smartphone, a tablet computer, or a personal computer, a computational photography server, etc. In other embodiments, the execution body may further be other electronic devices, which are not specifically limited here. As shown in FIG. 3, the specific steps of the method are as follows.

Step S10, obtaining first image data according to a preset rule.

In an implementation, the first image data refers to an original image on which image processing needs to be performed, and a target image requested by a user can be obtained by performing image processing on the original image.

The first image data may include: an image captured by an imaging module, and/or an image obtained from other modules.

In this embodiment, the preset rule is used to indicate that the first image data needs to be obtained. In addition, the preset rule may further indicate which types of characteristic data of the first image data need to be obtained, that is, which characteristic data of the first image data needs to be assigned to the data stream.

In addition, the preset rule may further indicate the specific manner for obtaining the first image data and/or various types of characteristic data.

In an implementation, the characteristic data of the first image data is used to describe the basic image information, imaging information, semantic information, etc. of the first image data. In addition, the characteristic data of the first image data may further include other relevant information of the first image data used in other image processing processes. This embodiment does not specifically limit the specific content of the characteristic data.

Step S20, determining or generating a target data stream according to the first image data.

After the first image data is obtained, a data stream including the first image data is determined or generated according to the first image data.

In an implementation, after the characteristic data of the first image data is obtained, the characteristic data may further be assigned to the data stream.

In an implementation, it is possible to assign, after each type of the required characteristic data is obtained, the each type of characteristic data to the data stream; or, firstly all the required characteristic data is obtained, and then all the required characteristic data is assigned to the data stream.

Step S30, performing image processing on the first image data based on the target data stream.

When the target data stream flows to any algorithm module or functional module, the any algorithm module or functional module may parse the target data stream, so as to obtain the first image data and/or characteristic data of the first image data included in the target data stream and perform image processing on the first image data.

In an implementation, the image processing performed on the first image data may include basic image processing and/or computational photography image processing.

In this embodiment, by obtaining the first image data according to the preset rule, determining or generating the target data stream according to the first image data, and performing image processing on the first image data based on the target data stream, subsequently when the first image data needs to be processed, the algorithm module or functional module can directly obtain the required first image data from the target data stream, and perform image processing on the first image data, thereby improving the image processing efficiency.

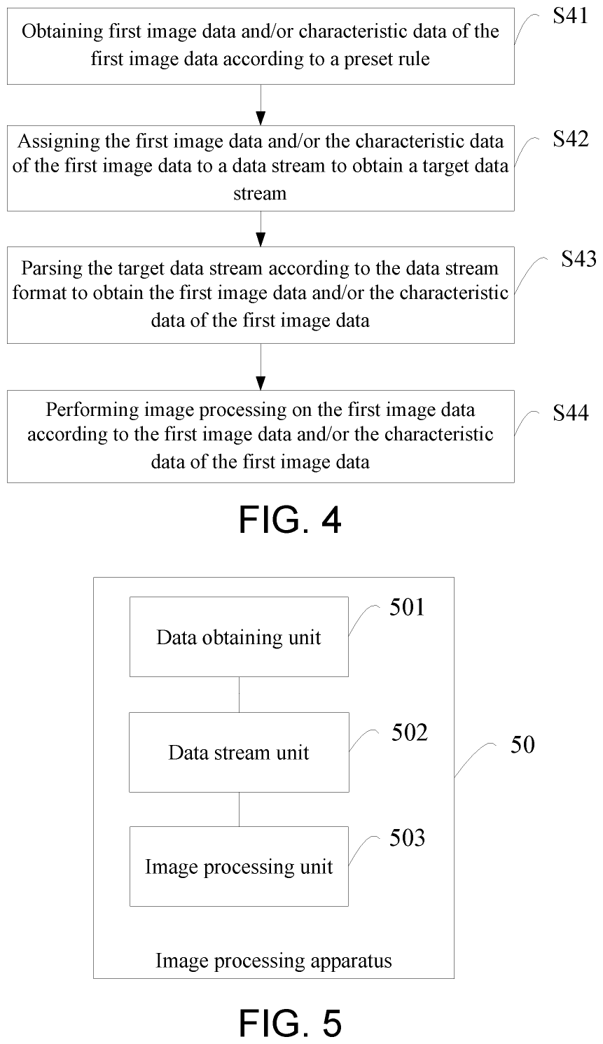

FIG. 4 is a flowchart of another image processing method according to an embodiment of the present application. Based on any of the above embodiments, in this embodiment, as shown in FIG. 4, the specific steps of the method are as follows.

Step S41, obtaining first image data and/or characteristic data of the first image data according to a preset rule.

In an optional implementation of this step, the computational photography system provides a first interface for obtaining image data, and the preset rule is configured in the first interface, and the preset rule is used to indicate that the first image data needs to be obtained. In addition, the preset rule may further indicate which types of characteristic data of the first image data need to be obtained, that is, which characteristic data of the first image data needs to be assigned to the data stream.

In response to calling the first interface for obtaining image data, the preset rule is obtained from an entry parameter of the first interface, and the first image data is obtained according to the preset rule.

In addition, the first interface is a relatively low-level interface. Based on the first interface, each APP or computational photography system may develop and provide an upper-level functional interface that can call the first interface in advance. This functional interface is used to realize the corresponding basic function. When the upper layer functional module or algorithm module applied by the APP or computational photography system calls the functional interface, the first interface can be automatically called.

For example, the functional module may be a photographing functional module, a video recording functional module, a video calling functional module, etc., or other functional modules that need to collect images. The functional interface may be a functional interface for obtaining image depth information, etc. In this step, if the preset rule instructs to add basic image information to the data stream, the basic image information of the first image data is obtained through the imaging module of the photography system.

In an implementation, the basic image information describes basic attribute information of the first image data, and the basic image information may include at least one of the following characteristic information of the first image data:
an image data length, an image width, an image height, an image format, a step size, a filling width, an image frame type, an image frame number.

In the computational photography system, the imaging module generates the first image data and can determine the basic attribute information of the image. In this step, the basic image information of the first image data may be obtained from the imaging module of the computational photography system, and then assigned to the data stream.

In an implementation, the basic image information of the first image data may be assigned by the imaging module to the data stream. Illustratively, the imaging module obtains the first image data and at the same time obtains the basic image information of the first image data, organizes the basic image information according to the format of the basic image information data item in the data stream format, and then assigns the basic image information to the data stream.

In this step, if the preset rule instructs to add imaging information to the data stream, the imaging information of the first image data is obtained from the imaging module and the auxiliary imaging module of the photography system.

In an implementation, the imaging information describes imaging-related attributes of the first image data, and the imaging information may include at least one of the following characteristic information of the first image data:
photosensitivity, an exposure value, a focal length, geographical location information.

In an implementation, the imaging information of the first image data may be obtained from the imaging module and the auxiliary imaging module of the computational photography system. The imaging information is organized according to the format of the imaging information data item in the data stream format, and then assigned to the data stream.

In this step, if the preset rule instructs to add at least one type of semantic information to the data stream, the at least one type of semantic information of the first image data is obtained.

In an implementation, semantic configuration information may be configured in the preset rule in advance, and the semantic configuration information includes the type of semantic information that needs to be added to the data stream.

In an implementation, the semantic information describes high-level semantic attributes of the first image data, and the semantic information may include at least one of the following characteristic information of the first image data:
scene information, an image depth, image semantics.

In an implementation, if the preset rule includes the semantic configuration information, and the semantic configuration information is used to instruct to add at least one type of semantic information to the data stream, then the at least one type of semantic information of the first image data is obtained.

In an implementation, the semantic information may also be divided into two categories: basic semantic information and optional semantic information. In an implementation, the basic semantic information may include one or more types of semantic information.

If the preset rule instructs to add basic semantic information to the data stream, the basic semantic information of the first image data is obtained; if the preset rule instructs to add optional semantic information to the data stream, at least one type of optional semantic information of the first image data is obtained.

Illustratively, if the preset rule includes first semantic configuration information, all types of basic semantic information must be obtained. In this step, if the preset rule includes the first semantic configuration information, and the first semantic configuration information is used to instruct to add basic semantic information to the data stream, then the basic semantic information of the first image data is obtained.

For the optional semantic information, second semantic configuration information may be configured in the preset rule, and one or more types of optional semantic information required to be obtained are configured in the second semantic configuration information. When obtaining the semantic information, only the optional semantic information configured in the second semantic configuration information needs to be obtained, but not necessarily all optional semantic information. In this step, if the preset rule includes the second semantic configuration information and the second semantic configuration information includes at least one type of optional semantic information, the at least one type of optional semantic information of the first image data is obtained.

For example, the basic semantic information may include: portrait segmentation information, salient object segmentation, lighting condition information (such as backlight, night scene, etc.), etc. The optional semantic information may include: depth information, photo scene information (such as indoor, party, etc.), object segmentation information (such as segmentation information of food, plants, etc.), etc.

In addition, what types of semantic information the basic semantic information includes and what types of semantic information the optional semantic information includes may be set and adjusted according to the needs of actual application scenarios, and are not specifically limited here.

For obtaining the semantic information, an image semantic extraction algorithm may be used to obtain the semantic information of the first image data.

In another optional implementation of this step, it is also possible to obtain, based on a request from each algorithm module, the characteristic data required by the current algorithm module.

In this step, in response to a request for the characteristic data from an algorithm module to which the data stream flows, the data required by the algorithm module (which may include the first image data, the characteristic data of the first image data, other data related to the first image data, etc.) are obtained. After the data required by the algorithm module is obtained, the obtained data is assigned to the data stream to obtain the target data stream including the first image data and/or the characteristic data of the first image data.

In an implementation, the computational photography system may provide a second interface for obtaining image characteristic data, which is a unified interface for obtaining various types of characteristic data. No matter what type of characteristic data of the first image data needs to be obtained, the algorithm module just calls the second interface and specifies the type of characteristic data that needs to be obtained in the input parameter of the second interface.

In this step, in response to any algorithm module calling the second interface, the data required by the algorithm module is determined or obtained according to the input parameter of the second interface, and the obtained data is transmitted to the algorithm module.

Step S42, assigning the first image data and/or the characteristic data of the first image data to a data stream to obtain a target data stream.

After the first image data and/or the characteristic data of the first image data is obtained, the first image data and/or the characteristic data of the first image data is assigned to the data stream according to the data stream format to obtain the target data stream.

In an implementation, it is possible to assign, after the first image data or each type of characteristic data of the first image data that is required is obtained, the first image data or the each type of characteristic data of the first image data that is required to the data stream; or, all required data is obtained first, and afterwards all the required data is assigned to the data stream.

The data stream format of the target data stream in this embodiment may be implemented using any data stream format provided in step S201 of the embodiment corresponding to FIG. 2. For details, reference may be made to step S201, which will not be described again here.

Step S43, parsing the target data stream according to the data stream format to obtain the first image data and/or the characteristic data of the first image data.

After the characteristic data of the first image data is assigned to the target data stream, during subsequent image processing, the target data stream is parsed according to the data stream format to obtain the first image data and/or the characteristic data of the first image data.

In an implementation, the data stream format is a preset format of a data stream including the first image data and/or the characteristic data of the first image data.

In this embodiment, the data stream format of the target data stream may be implemented by using any data stream format provided in step S201 of the embodiment corresponding to FIG. 2. For details, reference may be made to step S201, which will not be described again here.

Step S44, performing image processing on the first image data according to the first image data and/or the characteristic data of the first image data.

Illustratively, according to the respective pieces of characteristic information in the characteristic data of the first image data, one or more pieces of characteristic information used in the current image processing may be selected from the characteristic data, and corresponding image processing may be performed on the first image data, to obtain second image data and characteristic data of the second image data.

In this way, when performing image processing, the required characteristic data of the first image data can be obtained directly from the data stream without calling the query interface of each piece of characteristic data to obtain the characteristic data, which improves the image processing efficiency, reduces the dependence of the algorithm module for image processing on other modules (such as the module corresponding to the query interface) and improves the compatibility and consistency of the computational photography system.

In this embodiment, a unified first interface is provided, and when the first interface is called, the characteristic data of the first image data is obtained, and the characteristic data is assigned to the data stream; or, as required by each algorithm module, a unified second interface is called to obtain the characteristic data required by the algorithm module and the obtained characteristic data is assigned to the data stream, so that subsequently when there is a need to process the first image data, an algorithm module or a functional module can directly obtain the required characteristic data of the first image data from the data stream and perform image processing on the first image data, without a need to call the query interface of each piece of characteristic data to obtain the characteristic data, which improves the image processing efficiency, reduces the dependence of the algorithm module for image processing on other modules and improves the compatibility and consistency of the computational photography system.

FIG. 5 is a schematic structural diagram of an image processing apparatus according to an embodiment of the present application. The image processing apparatus provided by the embodiment of the present application can execute the method flow provided by the embodiment corresponding to FIG. 1 or the embodiment corresponding to FIG. 2. As shown in FIG. 5, the image processing apparatus 50 includes: a data obtaining unit 501, a data stream unit 502 and an image processing unit 503.

In an implementation, the data obtaining unit 501 is configured to perform step S1: obtaining first image data.

The data stream unit 502 is configured to perform step S2: determining or generating a target data stream according to a data stream format.

The image processing unit 503 is configured to perform step S3: performing image processing on the first image data according to the target data stream.

In an implementation, step S3 includes:
parsing the target data stream, and performing image processing on the first image data to obtain second image data and characteristic data of the second image data.

In an implementation, step S1 includes at least one of:
obtaining the first image data according to an imaging control instruction and/or an image obtaining instruction;
obtaining characteristic data of the first image data.

In an implementation, the characteristic data of the first image data includes at least one of: basic image information, imaging information, and semantic information of the first image data.

After obtaining the characteristic data of the first image data, the method further includes at least one of the following:
assigning the basic image information of the first image data to the target data stream;
assigning the imaging information of the first image data to the target data stream;
assigning the semantic information of the first image data to the target data stream.

In an implementation, the obtaining the characteristic data of the first image data includes:
obtaining the basic image information of the first image data through an imaging module of a photography system;
and/or, obtaining the imaging information of the first image data through the imaging module and/or an auxiliary imaging module of the photography system.

In an implementation, step S2 includes at least one of:
determining or generating the target data stream by arranging at least two data items sequentially in a first specific order;
determining or generating the target data stream by arranging respective pieces of characteristic information in a third specific order.

In an implementation, the method further includes at least one of the following: each of the data items includes at least one type of characteristic information; respective pieces of characteristic information in each of the data items are arranged in a second specific order.

The apparatus provided by the embodiment of the present application can be specifically configured to execute the method flow provided by the embodiment corresponding to FIG. 1 or the embodiment corresponding to FIG. 2, and the specific functions will not be described again here.

In the embodiment of the present application, a data stream format is set, captured first image data and characteristic data of the first image data are obtained, and a data stream including the first image data and the characteristic data is generated according to the data stream format, where the data stream includes not only the captured first image data, but also the characteristic data of the first image data. When performing any image processing on the first image data, the first image data and the characteristic data of the first image data can be obtained by parsing the data stream without a need to call the query interface of each piece of characteristic data to obtain the characteristic data, which improves the image processing efficiency, reduces the dependence of the algorithm module for image processing on other modules (such as the module corresponding to the query interface), and improves the compatibility and consistency of the computational photography system.

An embodiment of the present application further provides another image processing apparatus that can execute the method flow provided in the embodiment corresponding to FIG. 3 or the embodiment corresponding to FIG. 4. The image processing apparatus includes: a data obtaining unit, a data stream unit and an image processing unit.

In an implementation, the data obtaining unit is configured to perform step S10: obtaining first image data according to a preset rule.

The data stream unit is configured to perform step S20: determining or generating a target data stream according to the first image data.

The image processing unit is configured for S30: performing image processing on the first image data based on the target data stream.

In an implementation, step S10 includes at least one of:
if the preset rule instructs to add basic image information to a data stream, obtaining basic image information of the first image data through an imaging module of a photography system;
if the preset rule instructs to add imaging information to a data stream, obtaining imaging information of the first image data through the imaging module and/or an auxiliary imaging module of the photography system;
if the preset rule instructs to add at least one type of semantic information to a data stream, obtaining at least one type of semantic information of the first image data.

In an implementation, if the preset rule instructs to add at least one type of semantic information to a data stream, obtaining at least one type of semantic information of the first image data includes at least one of:
if the preset rule instructs to add basic semantic information to a data stream, obtaining the basic semantic information of the first image data;
if the preset rule instructs to add optional semantic information to a data stream, obtaining at least one type of optional semantic information of the first image data.

In an implementation, step S10 includes:
in response to a call to a first interface, obtaining the preset rule from an entry parameter of the first interface, and obtaining the first image data according to the preset rule.

In an implementation, step S20 includes:
in response to a data request from an algorithm module to which a data stream flows, obtaining data required by the algorithm module; and
after obtaining the data required by the algorithm module, assigning the obtained data to the data stream to obtain the target data stream.

In an implementation, in response to the data request from the algorithm module to which the data stream flows, obtaining the data required by the algorithm module includes:
in response to any algorithm module calling a second interface, determining or obtaining the data required by the algorithm module according to an input parameter of the second interface, and transmitting the obtained data to the algorithm module.

In an implementation, step S30 includes:
parsing the target data stream, and performing image processing on the first image data to obtain second image data and/or characteristic data of the second image data.

The apparatus provided by the embodiment of the present application can be specifically configured to execute the method flow provided by the above-mentioned embodiment corresponding to FIG. 3 or the embodiment corresponding to FIG. 4, and the specific functions will not be described again here.

In this embodiment, a unified first interface is provided, and when the first interface is called, the characteristic data of the first image data is obtained, and the characteristic data is assigned to the data stream; or, as required by each algorithm module, a unified second interface is called to obtain the characteristic data required by the algorithm module and the obtained characteristic data is assigned to the data stream, so that subsequently when there is a need to process the first image data, an algorithm module or a functional module can directly obtain the required characteristic data of the first image data from the data stream and perform image processing on the first image data, without a need to call the query interface of each piece of characteristic data to obtain the characteristic data, which improves the image processing efficiency, reduces the dependence of the algorithm module for image processing on other modules and improves the compatibility and consistency of the computational photography system.

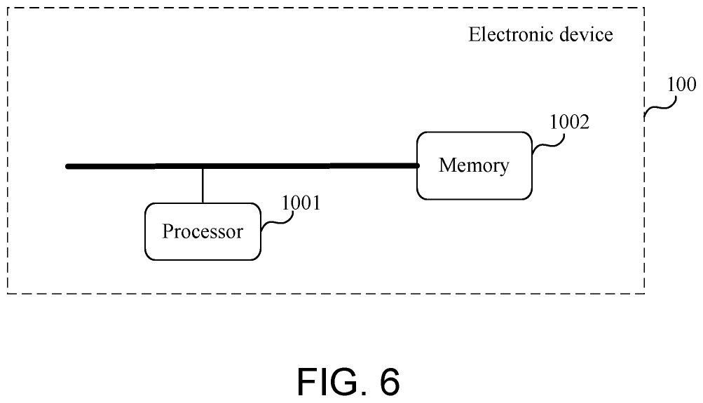

FIG. 6 is a schematic structural diagram of an electronic device according to an embodiment of the present application. As shown in FIG. 6, the electronic device 100 includes: a processor 1001 and a memory 1002. The memory 1002 stores computer execution instructions. In an implementation, the processor 1001 executes the computer execution instructions stored in the memory 1002, so that the processor 1001 performs the method flow provided by any of the above method embodiments. The specific functions will not be described again here.

In the embodiment of the present application, a data stream format is set, captured first image data and characteristic data of the first image data are obtained, and a data stream including the first image data and the characteristic data is generated according to the data stream format, where the data stream includes not only the captured first image data, but also the characteristic data of the first image data; during any image processing on the first image data, the first image data and the characteristic data of the first image data can be obtained by parsing the data stream without a need to call the query interface of each piece of characteristic data to obtain the characteristic data, which improves the image processing efficiency, reduces the dependence of the algorithm module for image processing on other modules (such as the module corresponding to the query interface), and improves the compatibility and consistency of the computational photography system.

The present application further provides a computational photography system, including: an imaging device, and at least one electronic device for implementing the method flow provided by any of the above method embodiments.

An embodiment of the present application further provides an intelligent terminal. The intelligent terminal includes a memory and a processor. An image processing program is stored in the memory. When the image processing program is executed by the processor, the steps of the image processing method in any of the above embodiments are implemented.

An embodiment of the present application further provides a computer-readable storage medium. An image processing program is stored on the computer-readable storage medium. When the image processing program is executed by a processor, the steps of the image processing method in any of the above embodiments are implemented.

In the embodiments of the intelligent terminal and the computer-readable storage medium provided by the embodiments of the present application, all the technical features of any of the above-mentioned image processing method embodiments may be included. The expansion and explanation content of the description are basically the same as those of the above-mentioned method embodiments. No further details will be given here.

An embodiment of the present application further provides a computer program product. The computer program product includes computer program codes. When the computer program codes are running on a computer, the computer is caused to perform the method in the above various possible implementations.

An embodiment of the present application further provides a chip which includes a memory and a processor. The memory is used to store a computer program. The processor is used to call and run the computer program from the memory, so that a device equipped with the chip performs the method in the above various possible implementations.

It can be understood that the above scenarios are only examples and do not constitute a limitation on the application scenarios of the technical solutions provided by the embodiments of the present application. The technical solutions of the present application may also be applied to other scenarios. For example, those of ordinary skill in the art know that with the evolution of system architecture and the emergence of new service scenarios, the technical solutions provided in the embodiments of the present application are also applicable to similar technical problems.

The above serial numbers of the embodiments of the present application are only for description and do not represent the advantages and disadvantages of the embodiments.

The steps in the methods of the embodiments of the present application may be adjusted in sequence, merged and deleted according to actual needs.

The units in the apparatuses of the embodiments of the present application may be merged, divided, and deleted according to actual needs.

In the present application, the same or similar terminology concepts, technical solutions and/or application scenario descriptions are generally only described in detail the first time they appear. When they appear again later, for the sake of simplicity, they are generally not described again. For understanding the technical solutions and other content of the present application, for the same or similar terminology concepts, technical solutions and/or application scenario descriptions that are not described in detail later, reference may be made to the relevant previous detailed descriptions.

In the present application, each embodiment is described with its own emphasis. For parts that are not detailed or recorded in a certain embodiment, reference may be made to the relevant descriptions of other embodiments.

The technical features of the technical solution of the present application may be combined in any way. In order to simplify the description, not all possible combinations of the technical features in the above embodiments are described. However, as long as there is no contradiction in the combination of these technical features, all possible combinations should be considered to be within the scope of the present application.

Through the above description of the embodiments, those skilled in the art can clearly understand that the methods of the above embodiments may be implemented by means of software plus the necessary general hardware platform, and of course, may also be implemented by hardware, but in many cases the former is better implementation. Based on this understanding, the technical solution of the present application in essence or the part that contributes to the prior art may be embodied in the form of a software product. The computer software product is stored in a storage medium as described above (such as a read-only memory (ROM), a random access memory (RAM), a magnetic disk, an optical disk), and includes several instructions to cause a terminal device (which may be a mobile phone, a computer, a server, a controlled terminal, or a network device, etc.) to perform the method of each embodiment of the present application.

The above embodiments may be implemented in whole or in part by software, hardware, firmware, or any combination thereof. For implementation using software, the embodiments may be implemented in whole or in part in the form of a computer program product. The computer program product includes one or more computer instructions. When the computer program instructions are loaded and executed on a computer, processes or functions according to the embodiments of the present application are generated in whole or in part. The computer may be a general purpose computer, a special purpose computer, a computer network, or other programmable device. The computer instructions may be stored in a computer-readable storage medium or may be transmitted from one computer-readable storage medium to another computer-readable storage medium. For example, the computer instructions may be transmitted from a website, computer, server or data center to another website site, computer, server or data center by wired (e.g. a coaxial cable, an optical fiber, a digital subscriber line) or wireless (such as infrared, wireless, microwave). The computer-readable storage medium may be any available medium that a computer can access or a data storage device such as a server, a data center that includes one or more available media integrations. An available medium may be a magnetic medium (e.g., a floppy disk, a storage disk, a tape), an optical medium (e.g., a DVD), or a semiconductor medium (e.g., Solid State Disk (SSD)), etc.

The above are only preferred embodiments of the present application, and are not intended to limit the patent scope of the present application. Any equivalent structure or equivalent process transformation made using the contents of the description and drawings of the present application or direct or indirect applications in other related technical fields are equally included in the patent protection scope of the present application.

What is claimed is:

1. An image processing method, comprising following steps:
S1, obtaining first image data;
S2, determining or generating a target data stream according to a data stream format; and
S3, performing image processing on the first image data according to the target data stream.

2. The method according to claim 1, wherein the step S3 comprises:
parsing the target data stream, and performing image processing on the first image data to obtain second image data and characteristic data of the second image data.

3. The method according to claim 1, wherein the step S1 comprises at least one of:
obtaining the first image data according to an imaging control instruction and/or an image obtaining instruction;
obtaining characteristic data of the first image data.

4. The method according to claim 3, wherein the characteristic data of the first image data comprises at least one of: basic image information, imaging information and semantic information of the first image data;
after the obtaining the characteristic data of the first image data, the method comprises at least one of:
assigning the basic image information of the first image data to the target data stream;
assigning the imaging information of the first image data to the target data stream;
assigning the semantic information of the first image data to the target data stream.

5. The method according to claim 4, wherein the obtaining the characteristic data of the first image data comprises at least one of:
obtaining the basic image information of the first image data through an imaging module of a photography system;
obtaining the imaging information of the first image data through at least one of the imaging module and an auxiliary imaging module of the photography system.

6. The method according to claim 1, wherein the step S2 comprises at least one of:
determining or generating the target data stream by arranging at least two data items sequentially in a first specific order;
determining or generating the target data stream by arranging respective pieces of characteristic information in a third specific order.

7. The method according to claim 6, further comprising at least one of:
each of the data items comprises at least one type of characteristic information;
respective pieces of characteristic information in each of the data items are arranged in a second specific order.

8. An image processing method, comprising following steps:
S10, obtaining first image data according to a preset rule;
S20, determining or generating a target data stream according to the first image data; and
S30, performing image processing on the first image data based on the target data stream.

9. The method according to claim 8, wherein the step S10 comprises at least one of:
if the preset rule instructs to add basic image information to a data stream, obtaining basic image information of the first image data through an imaging module of a photography system;
if the preset rule instructs to add imaging information to a data stream, obtaining imaging information of the first image data through the imaging module and/or an auxiliary imaging module of the photography system;
if the preset rule instructs to add at least one type of semantic information to a data stream, obtaining at least one type of semantic information of the first image data.

10. The method according to claim 9, wherein if the preset rule instructs to add at least one type of semantic information to a data stream, obtaining at least one type of semantic information of the first image data comprises at least one of:
if the preset rule instructs to add basic semantic information to a data stream, obtaining basic semantic information of the first image data;
if the preset rule instructs to add optional semantic information to a data stream, obtaining at least one type of optional semantic information of the first image data.

11. The method according to claim 8, wherein the step S10 comprises:
in response to a call to a first interface, obtaining the preset rule from an entry parameter of the first interface, and obtaining the first image data according to the preset rule.

12. The method according to claim 11, wherein the step S20 comprises:
in response to a data request from an algorithm module to which a data stream flows, obtaining data required by the algorithm module; and
after obtaining the data required by the algorithm module, assigning the obtained data to the data stream to obtain the target data stream.

13. The method according to claim 12, wherein in response to the data request from the algorithm module to which the data stream flows, obtaining the data required by the algorithm module comprises:
in response to a call to a second interface from any algorithm module, determining or obtaining the data required by the algorithm module according to an input parameter of the second interface, and transmitting the obtained data to the algorithm module.

14. The method according to claim 8, wherein the step S30 comprises:
parsing the target data stream, and performing image processing on the first image data to obtain second image data and/or characteristic data of the second image data.

15. An electronic device, comprising: a processor and a memory,
wherein the memory stores computer execution instructions; and
the computer execution instructions, when executed by the processor, cause the processor to:
obtain first image data;
determine or generate a target data stream according to a data stream format; and
perform image processing on the first image data according to the target data stream.

16. The electronic device according to claim 15, wherein the computer execution instructions, when executed by the processor, cause the processor to:
parse the target data stream, and perform image processing on the first image data to obtain second image data and characteristic data of the second image data.

17. The electronic device according to claim 15, wherein the computer execution instructions, when executed by the processor, cause the processor to perform at least one of:
obtaining the first image data according to an imaging control instruction and/or an image obtaining instruction;
obtaining characteristic data of the first image data.

18. The electronic device according to claim 15, wherein the computer execution instructions, when executed by the processor, cause the processor to perform at least one of:
determining or generating the target data stream by arranging at least two data items sequentially in a first specific order;
determining or generating the target data stream by arranging respective pieces of characteristic information in a third specific order.

19. An electronic device, comprising: a processor and a memory,
wherein the memory stores computer execution instructions; and
when the computer execution instructions are executed by the processor, the image processing method according to claim 8 is implemented.

20. A non-transitory computer-readable storage medium, wherein computer execution instructions are stored in the computer-readable storage medium, and when the computer execution instructions are executed by a processor, the image processing method according to claim 1 is implemented.
